(19) United States
(12) Patent Application Publication
(10) Pub. No.: US 2024/0404138 A1
(43) Pub. Date: Dec. 5, 2024

(54) AUTOMATIC REMOVAL OF LIGHTING EFFECTS FROM AN IMAGE

(71) Applicant: Adobe Inc., San Jose, CA (US)

(72) Inventors: He Zhang, Santa Clara, CA (US); Shi Yan, San Jose, CA (US); Jianming Zhang, Fremont, CA (US)

(73) Assignee: Adobe Inc., San Jose, CA (US)

(21) Appl. No.: 18/205,322

(22) Filed: Jun. 2, 2023

(51) Int. Cl. G06T 11/40; G06T 7/11; G06T 7/90

(52) U.S. Cl. CPC G06T 11/40; G06T 7/11; G06T 7/90; G06T 2207/20081; G06T 2207/20084; G06T 2207/20092; G06T 2207/30196

(57) ABSTRACT

In accordance with the described techniques, an image delighting system receives an input image depicting a human subject that includes lighting effects. The image delighting system further generates a segmentation mask and a skin tone mask. The segmentation mask includes multiple segments each representing a different portion of the human subject, and the skin tone mask identifies one or more color values for a skin region of the human subject. Using a machine learning lighting removal network, the image delighting system generates an unlit image by removing the lighting effects from the input image based on the segmentation mask and the skin tone mask.

### BACKGROUND

Camera devices, and in particular, camera devices integrated in mobile phones, have seen vast improvements in recent years. Given the capability and accessibility of these camera devices, more and more images are being captured by amateur photographers. These images, however, often include lighting effects (e.g., shadows and highlights) that are a result of the lighting conditions of the environment in which the images are captured, and are particularly noticeable for images that are taken in an outdoor environment.

Amateur photographers, however, typically lack the equipment and knowledge typically utilized by professional photographers to manipulate the lighting conditions at the time an image is captured. Rather, amateur photographers typically utilize photo editing applications to edit the lighting effects in an image after the image is captured. However, conventional lighting effect removal techniques often rely on user input to manually darken areas of highlights in the image and manually lighten areas of shadows in the image, which is a time consuming and tedious process. Moreover, unlit images produced using conventional model-based techniques often appear unrealistic or computer-generated.

### SUMMARY

Techniques for automatic removal of lighting effects from an image are described herein. In an example, a computing device implements an image delighting system to receive an input image depicting a human subject that includes lighting effects, e.g., shadows and highlights. In addition, the image delighting system receives user input specifying a skin tone color value for the depicted human subject. In accordance with the described techniques, separation mask is generated that separates the human subject from other depicted objects (e.g., a background) of the input image. Furthermore, a segmentation mask is generated by partitioning the input image into multiple segments that each represent a different portion of the human subject, e.g., hair, eyebrows, lips, eyes, clothes, etc. Moreover, a skin tone mask is generated by identifying a skin region that includes exposed skin of the human subject, and filling the skin region with the user-specified skin tone color value.

The input image, the separation mask, the segmentation mask, and the skin tone mask are provided, as conditioning, to a machine learning lighting removal network. Based on the conditioning, the machine learning lighting removal network generates an unlit image having the shadows and highlights of the input image removed. In addition, a lighting representation is generated having shading that represents the lighting effects removed from the input image to generate the unlit image. In accordance with the described techniques, the image delighting system receives user input editing the lighting representation. In response, the image delighting system updates the unlit image based on the edited lighting representation, such that the updated unlit image has the lighting effects represented by the updated unlit image removed from the input image.

This Summary introduces a selection of concepts in a simplified form that are further described below in the Detailed Description. As such, this Summary is not intended to identify essential features of the claimed subject matter, nor is it intended to be used as an aid in determining the scope of the claimed subject matter.

### BRIEF DESCRIPTION OF THE DRAWINGS

The patent or application file contains at least one drawing executed in color. Copies of this patent or patent application publication with color drawing(s) will be provided by the Office upon request and payment of the necessary fee.

The detailed description is described with reference to the accompanying figures. Entities represented in the figures are indicative of one or more entities and thus reference is made interchangeably to single or plural forms of the entities in the discussion.

FIG. 1 is an illustration of an environment in an example implementation that is operable to employ techniques described herein for automatic removal of lighting effects from an image.

FIG. 2 depicts a system in an example implementation showing operation of a delighting module.

FIG. 3 depicts a system in an example implementation showing operation of a lighting representation module.

FIG. 4 depicts an example showing a network architecture of a machine learning lighting removal network.

FIG. 5 depicts a system in an example implementation showing operation of a training module.

FIG. 6 depicts an example showing improved lighting effect removal results by way of utilizing a segmentation mask.

FIG. 7 depicts a procedure in an example implementation for automatic removal of lighting effects from an image.

FIG. 8 illustrates an example system including various components of an example device that can be implemented as any type of computing device as described and/or utilized with reference to FIGS. 1-7 to implement embodiments of the techniques described herein.

### DETAILED DESCRIPTION

### Overview

Image editing applications are often implemented for image delighting tasks, which involve removing the lighting effects (e.g., shadows and highlights) from an image. However, conventional lighting effect removal techniques often rely on user input to manually lighten areas of an image that include shadows, and manually darken areas of an image that include highlights, e.g., using a brightness and/or color adjusting brush. Not only is this a time consuming and tedious process for experienced users, but novice users of conventional image editing applications typically spend considerable time and effort learning the appropriate tools, and how to use the tools, to remove shadows and highlights from an image. Moreover, due to the multitude of possible lighting conditions for a scene, it is inherently difficult for model-based lighting effect removal techniques to accurately capture a human subject's true skin tone. As a result, conventional model-based techniques often overcompensate by flooding an image with color, thereby generating unlit images that fail to maintain the local facial details (e.g., wrinkles, skin discoloration) of an original image, and appear unrealistic or computer-generated.

Accordingly, techniques are discussed herein for automatic removal of lighting effects from an image that alleviate the fallbacks of conventional techniques. In an example, an image delighting system receives an input image that depicts a human subject and includes lighting effects, e.g., shadows and highlights. In addition, the image delighting system receives user input specifying a skin tone color value from a plurality of skin tone color values. In one or more implementations, the user is prompted to select a color, from a plurality of colors, that most closely resembles the skin tone of the human subject. Further, the image delighting system generates a separation mask from the input image. The separation mask separates the depicted human subject from other depicted objects in the input image, such as a background and/or objects obstructing the view of the human subject. Further, the image delighting system generates a segmentation mask by partitioning the input image into a plurality of segments each representing a different portion of the human subject. By way of example, the plurality of segments include one or more of a hair segment, an eyebrow segment, an eye segment, a lip segment, a neck segment, a clothing segment, and a face segment. Moreover, the image delighting system generates a skin tone mask. To do so, the image delighting system identifies a skin region in the input image that includes exposed skin of the human subject, and uniformly fills the skin region with the skin tone color value, e.g., so each pixel in the skin region has the skin tone color value.

The input image, the separation mask, the segmentation mask, and the skin tone mask are provided, as conditioning, to a machine learning lighting removal network. As output, the machine learning lighting removal network generates a first unlit image by removing the lighting effects from the input image. By way of example, the machine learning lighting removal network identifies areas of shadows and highlights in the skin region of the input image, and modifies the color values in corresponding areas of the first unlit image to be closer to the skin tone color value. In addition to removing the shadows and highlights from the skin region, the machine learning lighting removal network removes shadows and highlights from other regions of the depicted human subject (e.g., the hair region and the clothing region), in some implementations. During training, the machine learning lighting removal network learns to remove shadows and highlights from an input image using a machine learning process.

The machine learning lighting removal network includes a patch generation block, a hierarchical transformer encoder, and a decoder module. To generate the first unlit image, a combined input feature is generated by concatenating the input image, the separation mask, the segmentation mask, and the skin tone mask. The patch generation block receives the combined input feature and subdivides the combined input feature into a plurality of patches. The patches are provided as input to the hierarchical transformer encoder, which includes multiple transformer blocks. Each of the transformer blocks include an overlap patch merging block configured to merge neighboring patches by combining overlapping portions of the neighboring patches. Given this, a first transformer block outputs a first feature of the first unlit image at some fraction (e.g., ⅛) of the original resolution of the combined input feature. Moreover, a second transformer block of the hierarchical transformer encoder receives the first feature, as input, and outputs a second feature of the first unlit image at some further reduced fraction (e.g., 1/16) of the original resolution of the combined input feature. Therefore, each subsequent transformer block receives, as input, the feature output by a previous transformer block, and outputs a feature having a further reduced resolution. The features are then provided to a decoder module, which generates the first unlit image by combining the features.

Further, the image delighting system generates a second unlit image by shifting color values in the skin region of the first unlit image to be closer to the skin tone color value. In an example in which a pixel in the skin region of the first unlit image is a darker shade than the skin tone color value, the color shifting module modifies the color value of the pixel to have a lighter shade. In another example in which a pixel in the skin region of the first unlit image is a lighter shade than the skin tone color value, the color shifting module modifies the color value of the pixel to have a darker shade. As a result, the pixel color values in the skin region of the second unlit image are closer to the skin tone color value than the pixel color values in the skin region of the first unlit image.

In one or more implementations, the image delighting system is further configured to generate a lighting representation of the second unlit image based on the input image and the second unlit image. The lighting representation includes shading that represents removed shadows and highlights. Indeed, areas of lighter shading in the lighting representation identify corresponding areas of the second unlit image where the lighting effects are removed to a greater degree, e.g., the corresponding areas of the second unlit image are modified by a greater degree from the color values of the input image toward the skin tone color value. Further, areas of darker shading in the lighting representation identify corresponding areas of the second unlit image where the lighting effects are removed to a lesser degree, e.g., the corresponding areas of the second unlit image are closer to the color values of the input image.

In accordance with the described techniques, the image delighting system receives user input editing the lighting representation, and updates the second unlit image based on the edited lighting representation. In one example, the image delighting system receives user input lightening a location of the lighting representation. In response, the image delighting system further removes the lighting effects in a corresponding location of the second unlit image, e.g., by further modifying the color values in the corresponding location to be closer to the skin tone color value. In another example, the image delighting system receives user input darkening a location of the lighting representation. In response, the image delighting system reintroduces the lighting effects of the input image at a corresponding location of the second unlit image, e.g., by modifying the color values in the corresponding location to be closer to the color values of the input image.

In contrast to conventional input-based lighting effect removal techniques, the described techniques automatically remove shadows and highlights from the input image without user input apart from the user input to select the skin tone color value. Further, the described techniques generate an unlit image that maintains the local facial details (e.g., wrinkles and skin discoloration) of the input image, thereby generating an improved unlit image in comparison to conventional model-based techniques. This improvement is achieved by conditioning the machine learning lighting removal network on the user-specified skin tone color value and shifting the pixel color values of the output (e.g., the first unlit image) to be closer to the skin tone color value. By doing so, the image delighting system leverages the user's intuitive sense of skin tone while enabling the machine learning lighting removal network to focus on recovering the local facial details. Moreover, the lighting representation provides the user with precise control to fine tune the degree to which the lighting effects are removed. Thus, if the automatically generated results appear artificial to the user, it is possible for the user to fine tune the results to increase realism using the lighting representation, e.g., by decreasing an amount of the skin tone color value added at corresponding locations of the second unlit image. Accordingly, the described techniques generate an unlit image in a significantly reduced amount of time, as compared to conventional input-based techniques, and having increased realism, as compared to conventional model-based techniques.

In the following discussion, an example environment is described that employs the techniques described herein. Example procedures are also described that are performable in the example environment as well as other environments. Consequently, performance of the example procedures is not limited to the example environment and the example environment is not limited to performance of the example procedures.

### Example Environment

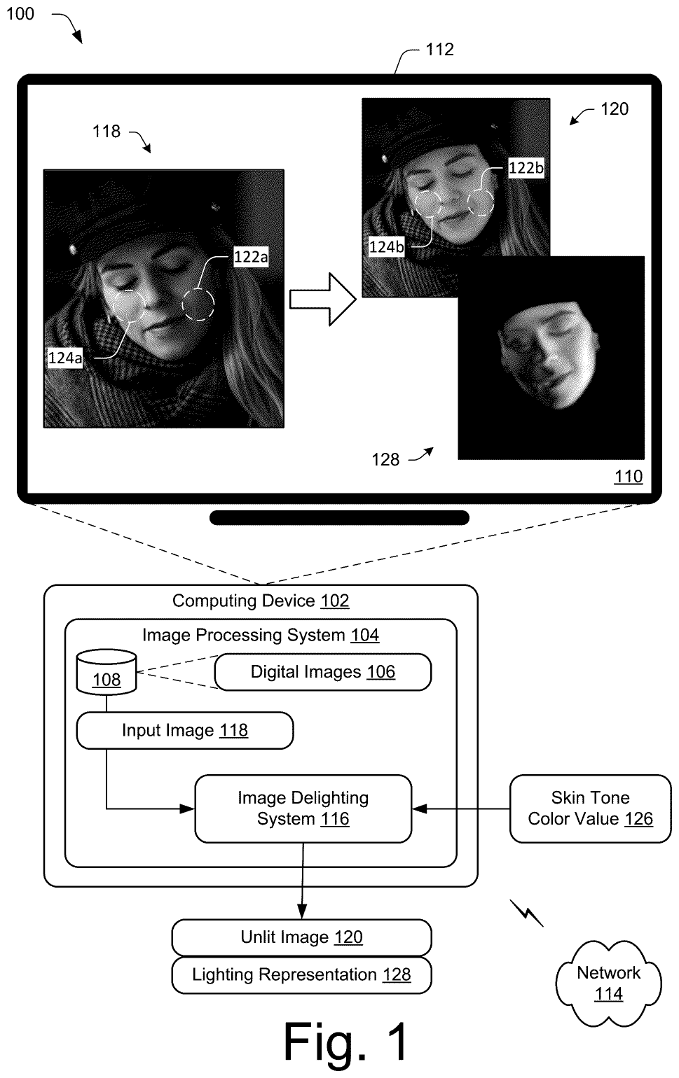

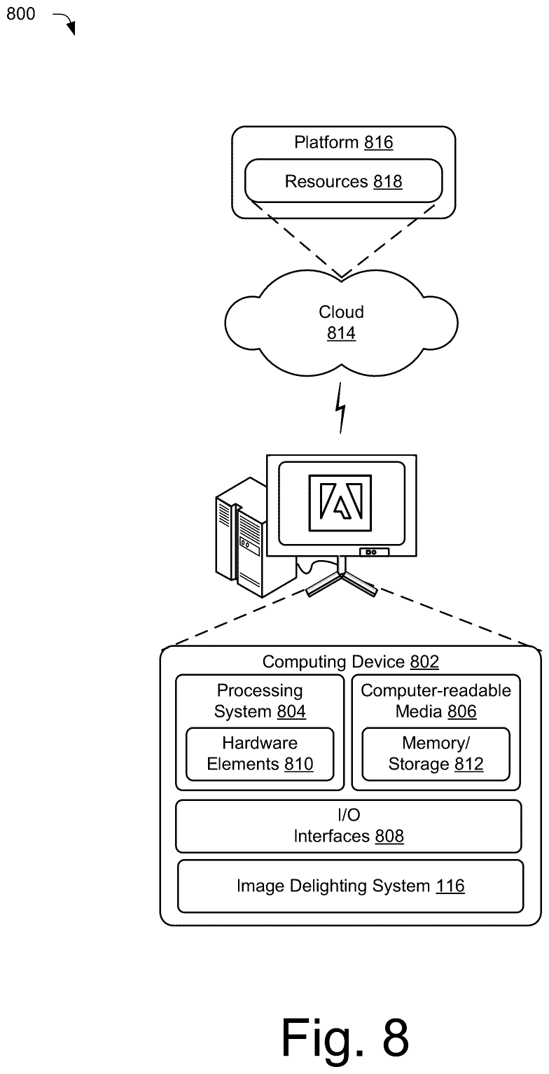

FIG. 1 is an illustration of an environment 100 in an example implementation that is operable to employ techniques described herein for automatic removal of lighting effects from an image. The illustrated environment 100 includes a computing device 102, which is configurable in a variety of ways. The computing device 102, for instance, is configurable as a desktop computer, a laptop computer, a mobile device (e.g., assuming a handheld configuration such as a tablet or mobile phone), and so forth. Thus, the computing device 102 ranges from full resource devices with substantial memory and processor resources (e.g., personal computers, game consoles) to a low-resource device with limited memory and/or processing resources (e.g., mobile devices). Additionally, although a single computing device 102 is shown, the computing device 102 is also representative of a plurality of different devices, such as multiple servers utilized by a business to perform operations “over the cloud” as described in FIG. 8.

The computing device 102 is illustrated as including an image processing system 104. The image processing system 104 is implemented at least partially in hardware of the computing device 102 to process and transform digital images 106, which are illustrated as maintained in storage 108 of the computing device 102. Such processing includes creation of the digital images 106, modification of the digital images 106, and rendering of the digital images 106 in a user interface 110 for output, e.g., by a display device 112. Although illustrated as implemented locally at the computing device 102, functionality of the image processing system 104 is also configurable as whole or part via functionality available via the network 114, such as part of a web service or “in the cloud.”

An example of functionality incorporated by the image processing system 104 to process the digital images 106 is illustrated as an image delighting system 116. In general, the image delighting system 116 is configured to receive an input image 118, and output an unlit image 120 by removing lighting effects (e.g., shadows and highlights) from the input image 118. As shown in the illustrated example, the input image 118 depicts a human subject that includes shadows (e.g., depicted at a first region 122a) and highlights, e.g., depicted at a second region 124a. Indeed, due to the lighting effects, the skin of the human subject in the first region 122a is generally a darker shade than the skin of the human subject in the second region 124a. In contrast, the first region 122b and the second region 124b of the unlit image 120 have substantially similar shading. Accordingly, the image delighting system 116 generates the unlit image 120 having the shadows removed from the first region 122b of the unlit image 120, and the highlights removed from the second region 124b of the unlit image 120.

To generate the unlit image, the image delighting system 116 employs a machine learning lighting removal network, and conditions the network on a skin tone mask. To generate the skin tone mask, the image delighting system 116 receives user input specifying a skin tone color value 126 for the depicted human subject. Further, the image delighting system 116 identifies a skin region in the input image 118 that includes exposed skin of the human subject, and fills the skin region with the skin tone color value 126. The skin tone mask is provided, as conditioning, to the image delighting system 116, which outputs an intermediate unlit image. The image delighting system 116 further incorporates the skin tone color value directly into the output of the network by shifting pixel color values in the skin region of the intermediate unlit image to be closer to the skin tone color value, resulting in the unlit image 120.

In one or more implementations, the machine learning lighting removal network additionally outputs a lighting representation 128 having shading that represents the lighting effects removed from the input image 118. By way of example, the lighting representation 128 includes lighter shading at locations where the lighting effects are removed from the input image 118 to a greater degree. In contrast, the lighting representation 128 includes darker shading at locations where the lighting effects are removed from the input image 118 to a lesser degree. In accordance with the described techniques, the image delighting system 116 receives user input (e.g., via the user interface 110) editing the lighting representation 128, and in response, the image delighting system 116 updates the unlit image 120 based on the edited lighting representation. By way of example, the image delighting system 116 receives user input darkening a region of the lighting representation 128, and the image delighting system 116 reintroduces the lighting effects of the input image 118 in a corresponding region of the unlit image 120, e.g., by modifying color values in the corresponding region of the unlit image 120 to be closer to the color values of the input image 118.

Conventional lighting effect removal techniques rely on user input to manually lighten areas of an image that include shadows, and manually darken areas of an image that include highlights, e.g., using a brightness and/or color adjusting brush. In contrast, the image delighting system 116 removes shadows and highlights from the input image 118 without user input apart from the user input to select the skin tone color value 126. Furthermore, due to the multitude of possible lighting conditions for a environment, it is inherently difficult for conventional model-based approaches for lighting effect removal to accurately capture a human subject's true skin tone. As a result, these conventional techniques often produce unlit images that appear artificial or computer-generated. To alleviate this difficulty, the image delighting system leverages the user-specified skin tone value as guidance, thereby causing the machine learning lighting removal network to focus on recovering the local facial details (e.g., wrinkles, skin discoloration) of the human subject without identifying the human subject's true skin tone. In addition, the lighting representation 128 provides the user with the ability to precisely control the degree to which the lighting effects of the input image 118 are removed, thereby enabling generation of an unlit image 120 that is aligned with the user's specific lighting effect removal preferences. In sum, the described techniques generate an unlit image in a significantly reduced amount of time, as compared to conventional input-based techniques, and with increased realism, as compared to conventional model-based techniques.

In general, functionality, features, and concepts described in relation to the examples above and below are employed in the context of the example procedures described in this section. Further, functionality, features, and concepts described in relation to different figures and examples in this document are interchangeable among one another and are not limited to implementation in the context of a particular figure or procedure. Moreover, blocks associated with different representative procedures and corresponding figures herein are applicable together and/or combinable in different ways. Thus, individual functionality, features, and concepts described in relation to different example environments, devices, components, figures, and procedures herein are usable in any suitable combinations and are not limited to the particular combinations represented by the enumerated examples in this description.

### Lighting Effect Removal Features

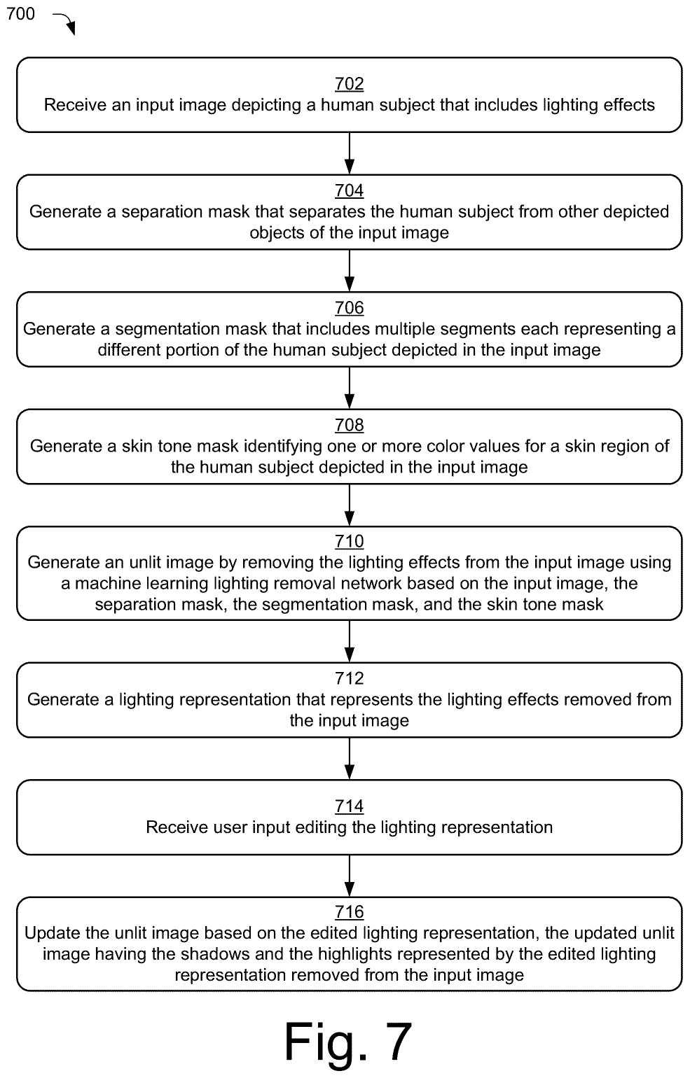

The following discussion describes techniques for automatic removal of lighting effects from an image that are implementable utilizing the previously described systems and devices. Aspects of each of the procedures are implemented in hardware, firmware, software, or a combination thereof. The procedures are shown as a set of blocks that specify operations performed by one or more devices and are not necessarily limited to the orders shown for performing the operations by the respective blocks. In portions of the following discussion, reference will be made to FIGS. 1-6 in parallel with procedure 700 of FIG. 7.

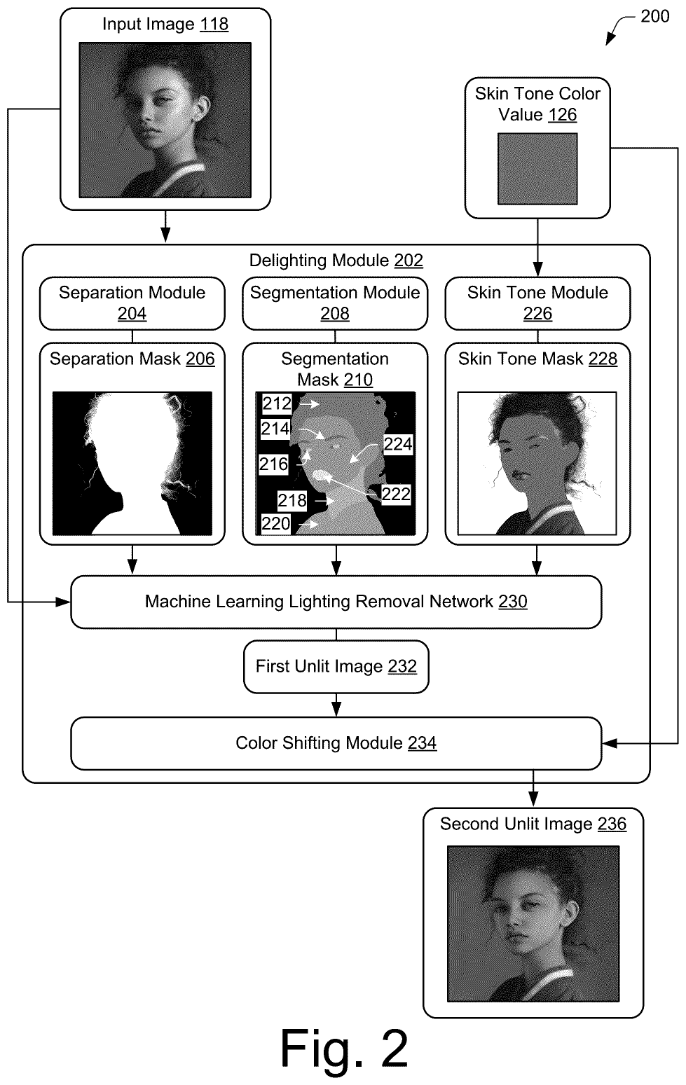

FIG. 2 depicts a system 200 in an example implementation showing operation of a delighting module 202. For example, the image delighting system 116 includes a delighting module 202 configured to receive an input image 118 depicting a human subject that includes lighting effects (block 702). By way of example, the input image 118 includes a human subject that is captured (e.g., by a camera) while exposed to lighting conditions. The lighting effects, for instance, include shadows and highlights on the surface (e.g., skin) of the human subject produced as a result of the surface interacting with the lighting conditions. Indeed, highlights on the surface of the human subject are produced as a result of the surface reflecting a light source, while the shadows are a result of the surface of the human subject (or some other obstacle) blocking a light source. Although depicted and described herein as an input image depicting a human subject, it is to be appreciated that the lighting effect removal techniques described herein are implementable to remove lighting effects from an image that depicts any suitable object, such as an animal, an indoor environment, an outdoor environment, and an inanimate object, to name just a few.

The delighting module 202 leverages a separation module 204 to generate a separation mask 206 that separates the human subject from other depicted portions of the input image 118 (block 704). As shown, the separation mask 206 includes a first portion (e.g., the white portion) that identifies where the human subject is located in the input image 118. Further, the separation mask 206 includes a second portion (e.g., the black portion) that identifies other depicted portions of the input image. In one or more implementations, the first portion (e.g., the white portion) excludes the background of the input image 118, and/or objects which obstruct the view of the human subject. Any of a variety of public or proprietary techniques are usable by the separation module 204 to generate the separation mask 206, one example of which is described in U.S. patent application Ser. No. 16/988,036 to Zhang et al., which is herein incorporated by reference in its entirety.

Further, the delighting module 202 leverages a segmentation module 208 to generate a segmentation mask 210 that includes multiple segments each representing a different portion of the human subject depicted in the input image (block 706). As shown, the segmentation mask 210 includes a first segment 212 that represents hair of the human subject, a second segment 214 that represents eyebrows of the human subject, a third segment 216 that represents eyes of the human subject, a fourth segment 218 that represents a neck of the human subject, a fifth segment 220 that represents clothing of the human subject, a sixth segment 222 that represents lips of the human subject, and a seventh segment 224 that represents a face of the human subject. It is to be appreciated that the segmentation mask 210 includes more or fewer segments representing different and/or additional features of the human subject, in variations. Any of a variety of public or proprietary techniques are usable by the segmentation module 208 to generate the segmentation mask 210, one example of which is described in U.S. patent application Ser. No. 18/170,336 to Liu et al., which is herein incorporated by reference in its entirety.

Moreover, the delighting module 202 leverages a skin tone module 226 to generate a skin tone mask 228 that identifies one or more color values for a skin region of the human subject depicted in the input image 118 (block 708). To do so, the delighting module 202 receives user input (e.g., via the user interface 110) selecting a skin tone color value 126 from a plurality of skin tone color values. For example, the user interface 110 displays a plurality of colors available for selection by the user. In one or more implementations, the user is prompted to select a color from the plurality of colors that most closely resembles the true skin tone of the human subject depicted in the input image 118. The skin tone color value 126 is provided to the skin tone module 226.

In accordance with the described techniques, the skin tone module 226 identifies a skin region of the input image 118 that includes exposed skin of the human subject. In one or more implementations, the skin tone module 226 identifies the skin region by selecting one or more segments of the segmentation mask 210 as the skin region. Indeed, as shown in the illustrated example, the skin tone module 226 selects the fourth segment 218 (e.g., identifying the neck of the human subject) and the seventh segment 224 (e.g., identifying the face of the human subject) as the skin region. Further, the skin tone module 226 uniformly fills the skin region with the skin tone color value 126, e.g., so each pixel in the skin region has the skin tone color value 126. In one or more implementations, the delighting module 202 is employed to generate the unlit image 120 without receiving user input specifying the skin tone color value 126. In these implementations, the skin tone module 226 determines an average color value in the skin region of the input image 118, and fills the skin region with the average color value, e.g., rather than the user-selected skin tone color value 126.

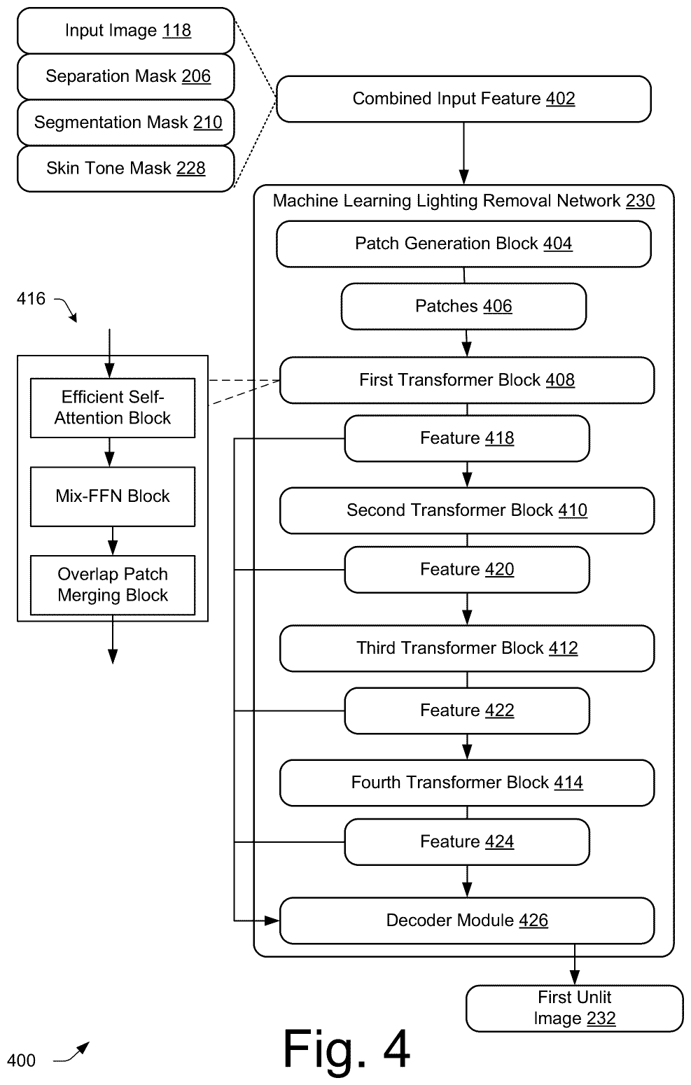

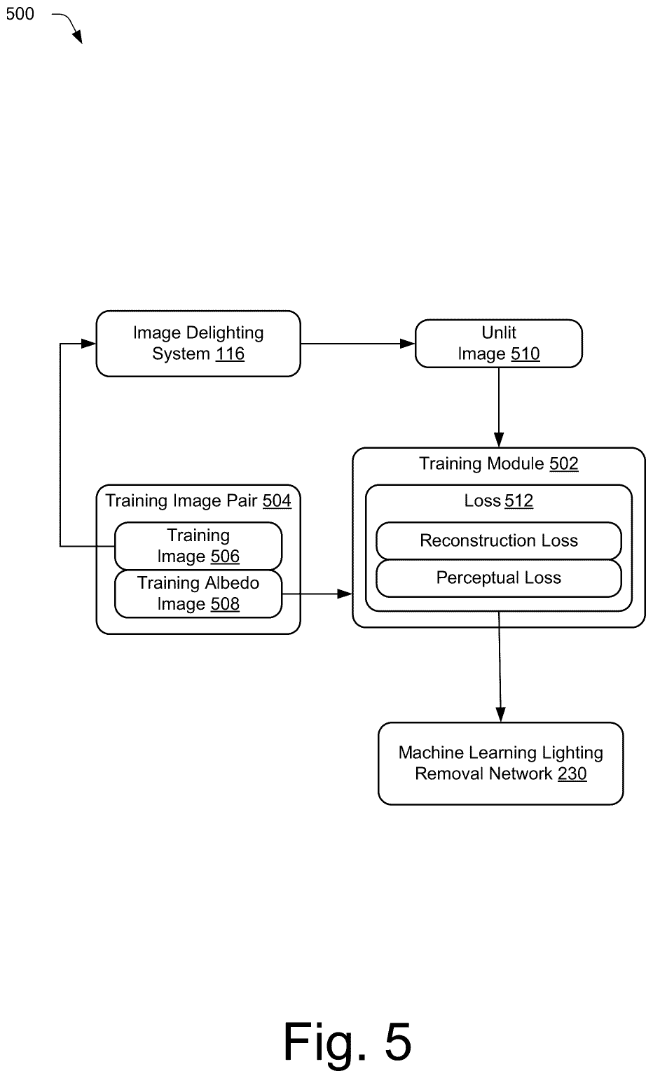

The delighting module 202 employs a machine learning lighting removal network 230 to generate an unlit image by removing the lighting effects from the input image 118 based on the input image 118, the separation mask 206, the segmentation mask 210, and the skin tone mask 228 (block 710). As part of this, the machine learning lighting removal network 230 receives, as conditioning, the input image 118, the separation mask 206, segmentation mask 210, and the skin tone mask 228. As output, the machine learning lighting removal network 230 generates a first unlit image 232 by removing the shadows and highlights from the input image 118. In the skin region, for instance, the machine learning lighting removal network 230 identifies areas of shadows and highlights in the skin region of the input image 118, and modifies the color values in corresponding areas of the first unlit image 232 to be closer to the skin tone color value 126. In effect, the machine learning lighting removal network outputs the first unlit image 232 having shadow areas lightened and highlight areas darkened, resulting in increased color consistency in the skin region of the first unlit image 232. In one or more implementations, the machine learning lighting removal network 230 removes shadows and highlights from all regions of the depicted human subject, e.g., the skin region, the hair region, the clothing region, etc. Further discussion of the architecture of the machine learning lighting removal network 230 is provided below with reference to FIG. 4. During training, the machine learning lighting removal network 230 is trained to remove the lighting effects from the input image 118 while maintaining the local facial details (e.g., wrinkles, skin discoloration) of the human subject, as further discussed below with reference to FIG. 5.

The first unlit image 232 is provided to a color shifting module 234, which is configured to shift pixel color values in the skin region of the first unlit image 232 to be closer to the skin tone color value 126. In an example in which a pixel in the skin region of the first unlit image 232 is a darker shade than the skin tone color value 126, the color shifting module 234 modifies the color value of the pixel to have a lighter shade. In another example in which a pixel in the skin region of the first unlit image 232 is a lighter shade than the skin tone color value 126, the color shifting module 234 modifies the color value of the pixel to have a darker shade. In variations, the color shifting module 234 shifts the pixel color values by up to a predetermined amount, and/or by a percentage of the difference between the skin tone color value 126 and the color value of the pixel in the skin region of the first unlit image 232. In one or more implementations, the color shifting module 234 shifts the pixel color value for each pixel in the skin region of the first unlit image 232 that does not match the skin tone color value 126. As shown, the color shifting module 234 outputs (e.g., for display in the user interface 110) a second unlit image 236 having the pixel color values in the skin region shifted to be closer to the skin tone color value 126, e.g., as compared to the first unlit image 232.

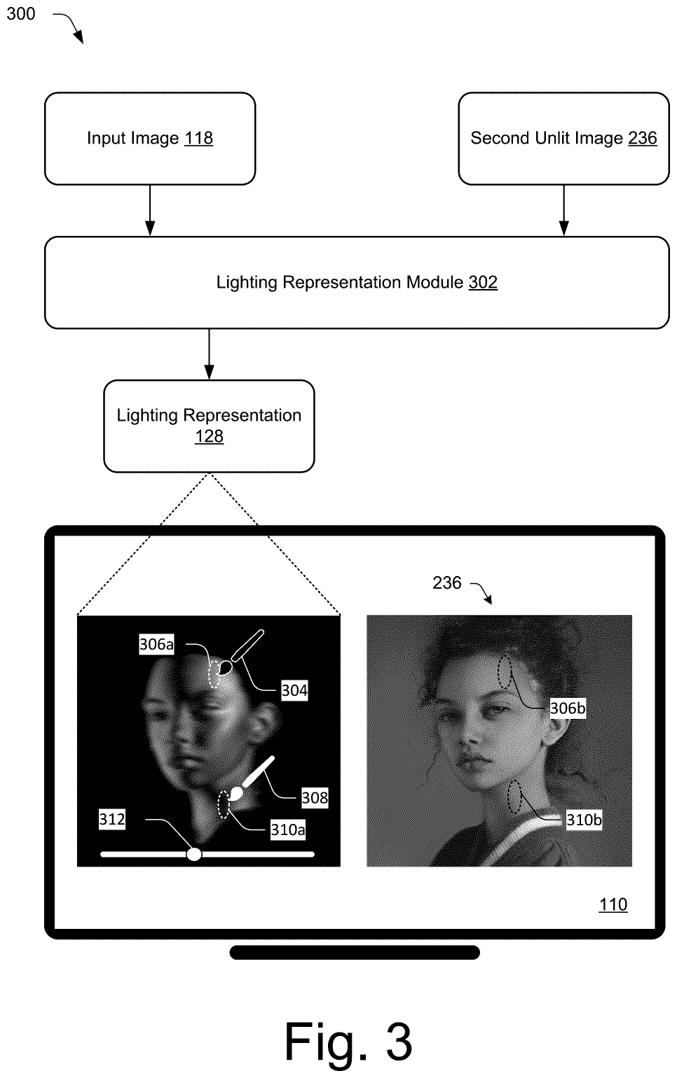

FIG. 3 depicts a system 300 in an example implementation showing operation of a lighting representation module 302. For example, the image delighting system 116 includes a lighting representation module 302 configured to generate a lighting representation 128 that represents the lighting effects removed from the input image 118 (block 712). To do so, the lighting representation module 302 receives the input image 118 and the second unlit image 236, and outputs a lighting representation 128 including shading that represents removed shadows and highlights. In accordance with the described techniques, lighter shading in the lighting representation 128 identifies areas in the second unlit image 236 where the lighting effects are removed from the input image 118 to a greater degree. In contrast, darker shading in the lighting representation 128 identifies areas in the second unlit image 236 where the lighting effects are removed to a lesser degree.

In at least one example, the shading in the lighting representation 128 represents an amount of the skin tone color value 126 added to corresponding areas of the input image 118 to produce the second unlit image 236. In this example, areas of lighter shading in the lighting representation 128 identify corresponding areas of the second unlit image 236 where the color of the second unlit image 236 is modified to a greater degree (e.g., from the color values of the input image 118 toward the skin tone color value 126), as compared to areas of darker shading in the lighting representation 128. Similarly, areas of darker shading in the lighting representation 128 identify corresponding areas in the second unlit image 236 that are closer to the color values of the input image 118, as compared to areas of lighter shading in the lighting representation 128.

Additionally or alternatively, the shading in the lighting representation 128 defines a degree of transparency for the skin tone mask 228, such that the input image 118 layered with the skin tone mask 228 having the degree of transparency produces the second unlit image 236. For instance, a black area of the lighting representation 128 identifies a corresponding area of the second unlit image 236 where the skin tone mask 228 is fully transparent, e.g., the color values in the corresponding area of the second unlit image 236 are the color values of the input image 118. Further, a white area of the lighting representation 128 identifies a corresponding area of the second unlit image 236 where the skin tone mask 228 is fully opaque, e.g., the color value in the corresponding area of the second unlit image 236 is the skin tone color value 126. Moreover, a gray area of the lighting representation 128 identifies a corresponding area of the second unlit image 236 where the skin tone mask 228 is semi-transparent, e.g., the color values in the corresponding area of the second unlit image 236 are borrowed partially from the skin tone mask 228 and partially from the input image 118. Notably, different shades of gray in the lighting representation 128 represent different degrees of semi-transparency for the skin tone mask 228. For example, lighter shades of gray in the lighting representation 128 represent areas of the second unlit image 236 where the color values are borrowed from the skin tone mask 228 to a greater degree, as compared to darker shades of gray in the lighting representation 128. As shown, the lighting representation 128 is output for display in the user interface 110 together with the second unlit image 236.

In accordance with the described techniques, the image delighting system 116 is configured to receive user input editing the lighting representation 128 (block 714). In one example, the user provides input via a darkening brush 304 at a first location 306a of the lighting representation 128, which darkens the first location 306a. In another example, the user provides input via a lightening brush 308 at a second location 310a of the lighting representation 128, which lightens the second location 310a. In yet another example, the user provides input via a slider control 312, which darkens and/or lightens the entire lighting representation 128, rather than just a portion of the lighting representation 128. For instance, the lighting representation module 302 lightens the entire lighting representation 128 in response to the slider control 312 being manipulated in a first direction, and the lighting representation module 302 darkens the entire lighting representation 128 in response to the slider control 312 being manipulated in a second direction. In one or more implementations, the user input solely modifies the shading in the skin region of the lighting representation 128, and not other regions (e.g., a background region, a hair region, a clothing region, etc.) of the lighting representation 128. Although depicted as a darkening brush 304, lightening brush 308, and a slider control 312, these examples are not to be construed as limiting, and other types of user interface elements are manipulable to darken and/or lighten the lighting representation 128, in variations.

Further, the lighting representation module 302 updates the unlit image based on the edited lighting representation, such that the updated unlit image has the lighting effects represented by the edited lighting representation removed from the input image 118 (block 716). By way of example, the image delighting system 116 further removes the shadows and highlights of the input image 118 in areas of the second unlit image 236 corresponding to areas of the lighting representation 128 that have been lightened by the user input. Moreover, the image delighting system 116 reintroduces the shadows and highlights of the input image 118 in areas of the second unlit image 236 corresponding to areas of the lighting representation 128 that have been darkened by the user input.

Thus, in response to receiving user input via the darkening brush 304 at the first location 306a, the lighting representation module 302 modifies the color values in a corresponding first region 306b of the second unlit image 236 to be closer to the color values of the input image 118. Further, in response to receiving user input via the lightening brush 308 at the second location 310a, the image delighting system 116 modifies the color values in a corresponding second region 310b of the second unlit image 236 to be closer to the skin tone color value 126. Additionally or alternatively, in response to receiving user input via the slider control 312 darkening the lighting representation 128, the image delighting system 116 modifies color values in the entire skin region of the second unlit image 236 to be closer to the color values of the input image 118. Similarly, in response to receiving user input via the slider control 312 lightening the lighting representation 128, the image delighting system 116 modifies color values in the entire skin region of the second unlit image 236 to be closer to the skin tone color value 126.

FIG. 4 depicts an example 400 showing a network architecture of a machine learning lighting removal network 230. As shown, the machine learning lighting removal network 230 receives, as conditioning, a combined input feature 402. By way of example, the image delighting system 116 generates the combined input feature 402 by concatenating the input image 118, the separation mask 206, the segmentation mask 210, and the skin tone mask 228. The combined input feature 402 is provided to a patch generation block 404, which subdivides the combined input feature 402 into a plurality of patches 406 of equal size, e.g., each of the pixels are four pixels by four pixels.

As shown, the patches 406 are provided to a hierarchical transformer encoder that includes multiple transformer blocks. Although depicted as including four transformer blocks (e.g., a first transformer block 408, a second transformer block 410, a third transformer block 412, and a fourth transformer block 414), it is to be appreciated that more or fewer transformer blocks are includable in the machine learning lighting removal network 230 in variations. An example architecture of the transformer blocks is depicted at 416. As shown, the transformer blocks 408, 410, 412, 414 each include an efficient self-attention block, a mix-feed forward network (FFN) block, and an overlap patch merging block. Broadly, the mix-FFN block is a feedforward layer that includes a 3×3 convolutional layer with zero padding and a multi-layer perceptron (MLP), which enables decreased information leakage. Further, the overlap patch merging block implements a convolutional layer having a stride that is less then the kernel size, which in effect, merges neighboring patches by combining overlapping portions of the neighboring patches 406.

Accordingly, the first transformer block 408 receives, as input, the patches 406 which are propagated through the efficient self-attention block, followed by the mix-FFN block, followed by the overlap patch merging block. As output, the first transformer block generates a feature 418 of the first unlit image 232. Since the overlap patch merging block merges neighboring patches, the feature 418 has a resolution that is a fraction of the original resolution of the combine input feature 402. Consider an example in which the combined input feature 402 has a 1024×1024 pixel resolution and the patch generation block 404 generates patches 406 having a 4×4 pixel resolution. In this example, the patches 406 coarsen the combined input feature 402 to a 256×256 patch resolution, e.g., ¼ of the original image resolution. By merging the neighboring patches 406, the feature 418 has a resolution that is a further reduced fraction (e.g., ⅛) of the original resolution of the combined input feature 402.

As shown, the feature 418 is provided, as input, to the second transformer block 410, which similarly outputs a feature 420 of the first unlit image 232. However, the feature 420 output by the second transformer block has a further reduced resolution, e.g., 1/16 of the original resolution of the combined input feature 402. Further, the third transformer block 412 receives the feature 420 as output by the second transformer block 410, and outputs a feature 422 having a further reduced resolution, e.g., 1/32 of the original resolution of the combined input feature 402. Similarly, the fourth transformer block 414 receives the feature 422 as output by the third transformer block 412, and outputs a feature 424 having a further reduced resolution, e.g., 1/64 of the original resolution of the combined input feature 402. Accordingly, the hierarchical transformer encoder generates multi-level features 418, 420, 422, 424 having different resolutions.

As shown, the multi-level features 418, 420, 422, 424 are provided to a decoder module 426, which generates the first unlit image 232 by concatenating the multi-level features 418, 420, 422, 424, and applying a transpose convolutional layer to the concatenated feature. In one or more implementations, supervised learning is implemented to supervise the output of the decoder module 426 (e.g., the first unlit image 232) with the feature output by a final transformer block of the hierarchical transformer encoder. By way of example, the feature 424 output by the fourth transformer block 414 is selected as the low-resolution ground truth of the first unlit image 232, and the first unlit image 232 is supervised with the feature 424.

FIG. 5 depicts a system 500 in an example implementation showing operation of a training module 502. In accordance with the described techniques, a training image dataset is built that includes a plurality of training images captured using a light stage. Broadly, the light stage includes a plurality of light sources surrounding a human subject, and the light sources are selectively illuminated to produce different lighting conditions. The training image dataset includes a plurality of training images 506, each depicting a respective one of multiple human subjects. Further, the different training images 506 depict different human subjects in different poses, and with different lighting conditions as produced by the light stage. For each human subject, one or more training albedo images 508 are captured with consistent lighting conditions (e.g., a particular set of light sources of the light stage illuminated) to accurately represent a skin tone of the human subject depicted in the training albedo image 508. By way of example, a training image pair 504 includes a training image 506 depicting a human subject in a pose while exposed to a set of lighting conditions, and a training albedo image 508 depicting the same human subject in the same or a substantially similar pose and exposed to a different set of lighting conditions, e.g., such that the different set of lighting conditions are used to capture each of the training albedo images 508 in the training image dataset.

As shown, the training albedo image 508 is provided to the training module 502, while the training image 506 is provided to the image delighting system 116. Broadly, the image delighting system 116 is configured to generate an unlit image 510 by removing the lighting effects from the training image 506 in accordance with the techniques discussed above with reference to FIG. 2. However, during training, the skin tone mask 228 has the skin region of the training image 506 filled with the average skin tone color value of the skin region in the training albedo image 508, rather than the user-specified skin tone color value 126. The unlit image 510 is provided to the training module 502.

The training module 502 uses machine learning to update the machine learning lighting removal network 230 to minimize a loss 512. Broadly, machine learning utilizes algorithms to learn from, and make predictions on, known data by analyzing the known data to learn to generate outputs that reflect patterns and attributes of the known data. By way of example, the machine learning lighting removal network 230 includes layers (e.g., convolutional layers, input, output, and hidden layers of MLPs, self-attention layers, feed forward layers, and transpose convolutional layers), and the training module 502 updates weights associated with the layers to minimize the loss 512. In one or more implementations, the loss 512 is representable as L=L_{R}+L_{P}, in which L_{R} represents reconstruction loss, and L_{P} represents perceptual loss.

To determine the reconstruction loss, the training module 502 computes the L1 distance between the unlit image 510 and the training albedo image 508. Further, the training module 502 utilizes a trained visual geometry group (VGG) network to determine the perceptual loss. Broadly, the VGG network identifies and classifies features of a subject depicted in an image, e.g., eyes, eyebrows, nose, lips, and the like for an image depicting a human subject. To determine the albedo perceptual loss, the training module 502 utilizes the VGG network to compute the distance between features in the unlit image 510 and corresponding features in the training albedo image 508.

After the loss 512 is computed, the training module 502 adjusts weights of layers associated with the machine learning lighting removal network 230 to minimize the loss 512. In a subsequent iteration, the training module 502 similarly adjusts the machine learning lighting removal network 230 to minimize a loss 512 computed based on a different training image pair 504, e.g., a different training image 506 and corresponding training albedo image 508. This process is repeated iteratively until the loss converges to a minimum, until a maximum number of iterations are completed, or until a maximum number of epochs have been processed. In response, the image delighting system 116 is deployed to generate an unlit image by removing the lighting effects from the input image 118 based on the skin tone color value 126.

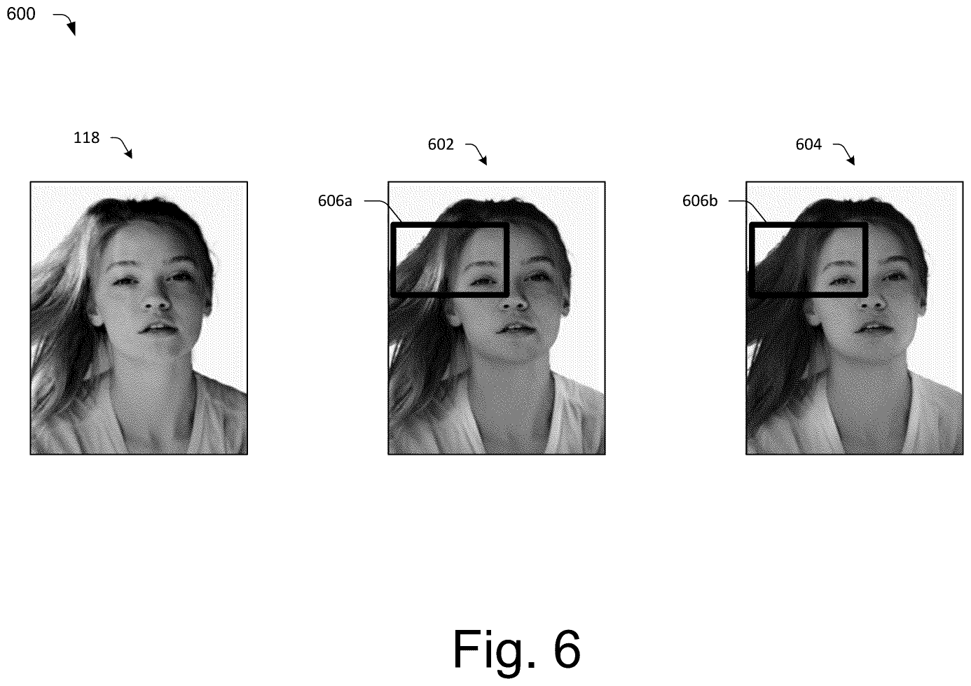

FIG. 6 depicts an example 600 showing improved lighting effect removal results by way of utilizing a segmentation mask 210. The example 600 includes an input image 118, an unlit image 602 generated by the delighting module 202 without conditioning the machine learning lighting removal network 230 on the segmentation mask 210, and an unlit image 604 generated by the delighting module 202 by conditioning the machine learning lighting removal network 230 on the segmentation mask 210. As shown, the unlit image 602 generated a highlight area 606a in the hair region of the human subject propagated from the input image 118. In contrast, a corresponding area 606b of the unlit image 604 is consistently colored with other portions of the hair region. Accordingly, the segmentation mask 210 alleviates region-specific color inconsistency difficulties typically encountered by learning-based approaches to lighting effect removal.

### Example System and Device

FIG. 8 illustrates an example system generally at 800 that includes an example computing device 802 that is representative of one or more computing systems and/or devices that implement the various techniques described herein. This is illustrated through inclusion of the image delighting system 116. The computing device 802 is configurable, for example, as a server of a service provider, a device associated with a client (e.g., a client device), an on-chip system, and/or any other suitable computing device or computing system.

The example computing device 802 as illustrated includes a processing system 804, one or more computer-readable media 806, and one or more I/O interface 808 that are communicatively coupled, one to another. Although not shown, the computing device 802 further includes a system bus or other data and command transfer system that couples the various components, one to another. A system bus can include any one or combination of different bus structures, such as a memory bus or memory controller, a peripheral bus, a universal serial bus, and/or a processor or local bus that utilizes any of a variety of bus architectures. A variety of other examples are also contemplated, such as control and data lines.

The processing system 804 is representative of functionality to perform one or more operations using hardware. Accordingly, the processing system 804 is illustrated as including hardware element 810 that is configurable as processors, functional blocks, and so forth. This includes implementation in hardware as an application specific integrated circuit or other logic device formed using one or more semiconductors. The hardware elements 810 are not limited by the materials from which they are formed or the processing mechanisms employed therein. For example, processors are configurable as semiconductor(s) and/or transistors (e.g., electronic integrated circuits (ICs)). In such a context, processor-executable instructions are electronically-executable instructions.

The computer-readable storage media 806 is illustrated as including memory/storage 812. The memory/storage 812 represents memory/storage capacity associated with one or more computer-readable media. The memory/storage 812 includes volatile media (such as random access memory (RAM)) and/or nonvolatile media (such as read only memory (ROM), Flash memory, optical disks, magnetic disks, and so forth). The memory/storage 812 includes fixed media (e.g., RAM, ROM, a fixed hard drive, and so on) as well as removable media (e.g., Flash memory, a removable hard drive, an optical disc, and so forth). The computer-readable media 806 is configurable in a variety of other ways as further described below.

Input/output interface(s) 808 are representative of functionality to allow a user to enter commands and information to computing device 802, and also allow information to be presented to the user and/or other components or devices using various input/output devices. Examples of input devices include a keyboard, a cursor control device (e.g., a mouse), a microphone, a scanner, touch functionality (e.g., capacitive or other sensors that are configured to detect physical touch), a camera (e.g., employing visible or non-visible wavelengths such as infrared frequencies to recognize movement as gestures that do not involve touch), and so forth. Examples of output devices include a display device (e.g., a monitor or projector), speakers, a printer, a network card, tactile-response device, and so forth. Thus, the computing device 802 is configurable in a variety of ways as further described below to support user interaction.

Various techniques are described herein in the general context of software, hardware elements, or program modules. Generally, such modules include routines, programs, objects, elements, components, data structures, and so forth that perform particular tasks or implement particular abstract data types. The terms “module,” “functionality,” and “component” as used herein generally represent software, firmware, hardware, or a combination thereof. The features of the techniques described herein are platform-independent, meaning that the techniques are configurable on a variety of commercial computing platforms having a variety of processors.

An implementation of the described modules and techniques is stored on or transmitted across some form of computer-readable media. The computer-readable media includes a variety of media that is accessed by the computing device 802. By way of example, and not limitation, computer-readable media includes “computer-readable storage media” and “computer-readable signal media.”

“Computer-readable storage media” refers to media and/or devices that enable persistent and/or non-transitory storage of information in contrast to mere signal transmission, carrier waves, or signals per se. Thus, computer-readable storage media refers to non-signal bearing media. The computer-readable storage media includes hardware such as volatile and non-volatile, removable and non-removable media and/or storage devices implemented in a method or technology suitable for storage of information such as computer readable instructions, data structures, program modules, logic elements/circuits, or other data. Examples of computer-readable storage media include but are not limited to RAM, ROM, EEPROM, flash memory or other memory technology, CD-ROM, digital versatile disks (DVD) or other optical storage, hard disks, magnetic cassettes, magnetic tape, magnetic disk storage or other magnetic storage devices, or other storage device, tangible media, or article of manufacture suitable to store the desired information and are accessible by a computer.

“Computer-readable signal media” refers to a signal-bearing medium that is configured to transmit instructions to the hardware of the computing device 802, such as via a network. Signal media typically embodies computer readable instructions, data structures, program modules, or other data in a modulated data signal, such as carrier waves, data signals, or other transport mechanism. Signal media also include any information delivery media. The term “modulated data signal” means a signal that has one or more of its characteristics set or changed in such a manner as to encode information in the signal. By way of example, and not limitation, communication media include wired media such as a wired network or direct-wired connection, and wireless media such as acoustic, RF, infrared, and other wireless media.

As previously described, hardware elements 810 and computer-readable media 806 are representative of modules, programmable device logic and/or fixed device logic implemented in a hardware form that are employed in some embodiments to implement at least some aspects of the techniques described herein, such as to perform one or more instructions. Hardware includes components of an integrated circuit or on-chip system, an application-specific integrated circuit (ASIC), a field-programmable gate array (FPGA), a complex programmable logic device (CPLD), and other implementations in silicon or other hardware. In this context, hardware operates as a processing device that performs program tasks defined by instructions and/or logic embodied by the hardware as well as a hardware utilized to store instructions for execution, e.g., the computer-readable storage media described previously.

Combinations of the foregoing are also be employed to implement various techniques described herein. Accordingly, software, hardware, or executable modules are implemented as one or more instructions and/or logic embodied on some form of computer-readable storage media and/or by one or more hardware elements 810. The computing device 802 is configured to implement particular instructions and/or functions corresponding to the software and/or hardware modules. Accordingly, implementation of a module that is executable by the computing device 802 as software is achieved at least partially in hardware, e.g., through use of computer-readable storage media and/or hardware elements 810 of the processing system 804. The instructions and/or functions are executable/operable by one or more articles of manufacture (for example, one or more computing devices 802 and/or processing systems 804) to implement techniques, modules, and examples described herein.

The techniques described herein are supported by various configurations of the computing device 802 and are not limited to the specific examples of the techniques described herein. This functionality is also implementable all or in part through use of a distributed system, such as over a “cloud” 814 via a platform 816 as described below.

The cloud 814 includes and/or is representative of a platform 816 for resources 818. The platform 816 abstracts underlying functionality of hardware (e.g., servers) and software resources of the cloud 814. The resources 818 include applications and/or data that can be utilized while computer processing is executed on servers that are remote from the computing device 802. Resources 818 can also include services provided over the Internet and/or through a subscriber network, such as a cellular or Wi-Fi network.

The platform 816 abstracts resources and functions to connect the computing device 802 with other computing devices. The platform 816 also serves to abstract scaling of resources to provide a corresponding level of scale to encountered demand for the resources 818 that are implemented via the platform 816. Accordingly, in an interconnected device embodiment, implementation of functionality described herein is distributable throughout the system 800. For example, the functionality is implementable in part on the computing device 802 as well as via the platform 816 that abstracts the functionality of the cloud 814.

### CONCLUSION

Although the invention has been described in language specific to structural features and/or methodological acts, it is to be understood that the invention defined in the appended claims is not necessarily limited to the specific features or acts described. Rather, the specific features and acts are disclosed as example forms of implementing the claimed invention.

What is claimed is:

1. A method, comprising:
receiving, by a processing device, an input image depicting a human subject that includes lighting effects;
generating, by the processing device, a segmentation mask that includes multiple segments each representing a different portion of the human subject depicted in the input image;
generating, by the processing device, a skin tone mask identifying one or more color values for a skin region of the human subject depicted in the input image; and
generating, by the processing device and using a machine learning lighting removal network, an unlit image by removing the lighting effects from the input image based on the segmentation mask and the skin tone mask.

2. The method of claim 1, wherein the generating the skin tone mask includes:
receiving user input specifying the one or more color values;
selecting one or more of the multiple segments as the skin region; and
filling the skin region with the one or more color values.

3. The method of claim 1, wherein the one or more color values correspond to a single color, and wherein the generating the unlit image includes shifting pixel color values in the skin region of the unlit image to be closer to the single color.

4. The method of claim 1, further comprising generating, by the processing device, a separation mask that separates the human subject from other depicted objects of the input image, and wherein the generating the unlit image includes conditioning the machine learning lighting removal network on the input image, the separation mask, the segmentation mask, and the skin tone mask.

5. The method of claim 4, wherein the generating the unlit image includes:
generating, by the processing device, a combined input feature by concatenating the input image, the skin tone mask, the segmentation mask, and the separation mask; and
subdividing, by a patch generation block, the combined input feature into a plurality of patches.

6. The method of claim 5, wherein the generating the unlit image includes outputting, by a first transformer block of multiple transformer blocks of the machine learning lighting removal network, a feature of the unlit image based on the plurality of patches.

7. The method of claim 6, wherein the generating the unlit image includes performing, for each additional transformer block of the multiple transformer blocks, the outputting the feature of the unlit image based on the feature output by a previous transformer block, the features output by different ones of the multiple transformer blocks having different resolutions.

8. The method of claim 7, wherein the generating the unlit image includes combining, by a decoder module of the machine learning lighting removal network, the features output by the multiple transformer blocks.

9. The method of claim 8, wherein the generating the unlit image includes supervising the decoder module with the feature output by a final transformer block of the multiple transformer blocks.

10. The method of claim 1, further comprising generating, by the processing device, a lighting representation that represents the lighting effects removed from the input image.

11. The method of claim 10, further comprising:
receiving, by the processing device, user input editing the lighting representation; and
updating, by the processing device, the unlit image based on the edited lighting representation, the updated unlit image having the lighting effects represented by the edited lighting representation removed from the input image.

12. A system, comprising:
a processing device; and
a computer-readable storage media storing instructions that, responsive to execution by the processing device, cause the processing device to perform operations including:
receiving user input specifying a skin tone color value for a human subject depicted in an input image that includes shadows and highlights;
generating a skin tone mask having a skin region of the human subject filled with the skin tone color value;
generating, using a machine learning lighting removal network, a first unlit image by removing the shadows and the highlights from the input image based on the skin tone mask; and
generating a second unlit image by shifting color values in the skin region of the first unlit image to be closer to the skin tone color value.

13. The system of claim 12, the operations further including:
generating a separation mask that separates the human subject from other depicted objects of the input image; and
generating a segmentation mask that includes multiple segments each representing a different portion of the human subject depicted in the input image.

14. The system of claim 13, the operations further comprising identifying the skin region by selecting one or more of the multiple segments as the skin region.

15. The system of claim 13, wherein the generating the first unlit image includes conditioning the machine learning lighting removal network on the input image, the separation mask, the segmentation mask, and the skin tone mask.

16. A non-transitory computer-readable medium storing executable instructions, which when executed by a processing device, cause the processing device to perform operations comprising:
receiving an input image that includes lighting effects;
generating, using a machine learning lighting removal network, an unlit image by removing the lighting effects from the input image;
generating a lighting representation that represents the lighting effects removed from the input image;
receiving user input editing the lighting representation; and
updating the unlit image based on the edited lighting representation, the updated unlit image having the lighting effects represented by the edited lighting representation removed from the input image.

17. The non-transitory computer-readable medium of claim 16, wherein the lighting effects removed from the input image are represented by shading of the lighting representation, wherein lighter shading in the lighting representation identifies portions of the unlit image having the lighting effects removed from the input image to a greater degree, and wherein darker shading in the lighting representation identifies portions of the unlit image having the lighting effects removed from the input image to a lesser degree.

18. The non-transitory computer-readable medium of claim 17, wherein the receiving the user input editing the lighting representation includes receiving user input updating a location of the lighting representation to have lighter shading, and wherein the updating the unlit image includes further removing the lighting effects in a corresponding location of the unlit image.

19. The non-transitory computer-readable medium of claim 17, wherein the receiving the user input editing the lighting representation includes receiving user input updating a location of the lighting representation to have darker shading, and wherein the updating the unlit image includes reintroducing the lighting effects of the input image at a corresponding location of the unlit image.

20. The non-transitory computer-readable medium of claim 16, wherein the input image depicts a human subject, and wherein the generating the unlit image includes:
generating a separation mask that separates the human subject from other depicted objects of the input image;
generating a segmentation mask that includes multiple segments each representing a different portion of the human subject depicted in the input image;
generating a skin tone mask that identifies a skin region of the human subject and having the skin region filled with a skin tone color value; and
conditioning the machine learning lighting removal network on the input image, the separation mask, the segmentation mask, and the skin tone mask.
